(19) United States
(12) Patent Application Publication
(10) Pub. No.: US 2009/0204397 A1
(43) Pub. Date: Aug. 13, 2009

(54) LINEAR PREDICTIVE CODING OF AN AUDIO SIGNAL

(76) Inventor: Albertus Cornelis Den Drinker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/302,071

(22) PCT Filed: May 15, 2007
(86) PCT No.: PCT/IB07/51832

§ 371 Date: Nov. 24, 2008

(30) Foreign Application Priority Data
May 30, 2006 (EP) 06114670.0

(51) Int. Cl. G10L 19/06

(52) U.S. Cl. 704/217; 704/E19.001

(57) ABSTRACT

An apparatus for linear predictive coding of an audio signal comprises a segmentation processor (201) which generates signal segments for the audio signal. An autocorrelation processor (401) for generates a first autocorrelation sequence for each signal segment and a modification processor (403) generates a second autocorrelation sequence for each signal segment by modifying the first autocorrelation sequence in response to at least one psychoacoustic characteristic. A prediction coefficient processor (405) determines linear predictive coding coefficients for each signal segment in response to the second autocorrelation sequence. The invention allows a low complexity linear encoding which takes into account psychoacoustic considerations thereby allowing an improved perceived coding quality for a given data rate.

The invention relates to linear predictive coding of an audio signal.

Digital coding of various source signals has become increasingly important over the last decades as digital signal representation and communication increasingly has replaced analogue representation and communication. For example, mobile telephone systems, such as the Global System for Mobile communication, are based on digital speech coding. Also distribution of media content, such as video and music, is increasingly based on digital content coding.

In content coding, and in particular in audio and speech coding, linear predictive coding is an often employed tool as it provides high quality for low data rates. Linear predictive coding has in the past mainly been applied to individual signals but is also applicable to multi channel signals such as for example stereo audio signals.

Linear prediction coding achieves effective data rates by reducing the redundancies in the signal and capturing these in prediction parameters. The prediction parameters are included in the encoded signal and the redundancies are restored in the decoder by a linear prediction synthesis filter.

Linear prediction has furthermore been proposed as a pre-processing tool for audio coding including non-speech coding applications. It has specifically been suggested that the best linear prediction schemes should reflect the psychoacoustic knowledge to more accurately reflect the perceptions of a listener. In particular, Warped Linear Prediction (WLP) and Pure Linear Prediction (PLP) techniques have been proposed. Both techniques include a warping of the frequency scale in accordance with psycho-acoustics thereby enabling a concentration of modeling capability at the most critical frequency bands. Specifically, WLP and PLP allow a focus on the lower frequencies in a way that resembles the bandwidth distribution across the basilar membrane. This also implies that spectral peak broadening can be performed efficiently on a psycho-acoustic relevant scale in WLP and PLP.

Furthermore, it has been suggested that the prediction coefficients can be derived from a perceptually motivated spectrum like the loudness spectrum or the masked threshold (or masked error power). Thus, in the proposed system, the signal to be encoded is fed to a psychoacoustic model which generates a spectrum (e.g. a masked threshold) for the specific signal segment reflecting the psychoacoustic quantity of interest. This spectrum is then used to generate the prediction coefficients for the linear predictive filter.

However, although this approach allows linear prediction for audio coding which takes into account the psychoacoustic masking effects, it also has a number of disadvantages. Specifically, the approach requires that a psycho-acoustic model is executed for each signal segment which is complex and computationally expensive. Furthermore, the approach tends to be inflexible and specifically requires that the prediction filter is either a Warped or Laguerre filter in order to operate on a psycho-acoustically relevant frequency scale.

Hence, an improved linear predictive coding would be advantageous and in particular an approach allowing increased flexibility, reduced complexity, facilitated implementation, improved encoding quality and/or improved performance would be advantageous.

Accordingly, the Invention seeks to preferably mitigate, alleviate or eliminate one or more of the above mentioned disadvantages singly or in any combination.

According to an aspect of the invention there is provided an apparatus for linear predictive coding of an audio signal, the apparatus comprising: means for generating signal segments for the audio signal; means for generating a first autocorrelation sequence for each signal segment; modifying means for generating a second autocorrelation sequence for each signal segment by modifying the first autocorrelation sequence in response to at least one psychoacoustic characteristic; and determining means for determining linear predictive coding coefficients for each signal segment in response to the second autocorrelation sequence.

The invention allows an improved linear predictive coding which reflects the perception of a listener thereby providing improved coding quality for a given coding rate. The invention may allow reduced complexity, reduced computational resource demand and/or facilitated implementation. The invention may furthermore allow psychoacoustic considerations to be used with a variety of different linear predictive coding approaches.

Specifically, the invention may allow the calculation of a psychoacoustically weighted autocorrelation sequence to be determined from a first autocorrelation sequence. The calculation may be lower complexity yet provide an efficient adaptation to the psychoacoustic properties.

The apparatus may furthermore comprise means for generating an encoded data stream comprising the linear predictive coding coefficients. The apparatus may also comprise means for transmitting the encoded data stream for example as a data file. The apparatus may furthermore comprise a linear predictive filter employing the linear predictive coding coefficients and means for generating an error signal. The apparatus may also comprise means for encoding the error signal and for including these in the encoded data stream.

According to an optional feature of the invention, the modifying means is arranged to perform a windowing of the first autocorrelation sequence.

This may allow improved performance, higher quality, reduced complexity and/or facilitated implementation. The windowing may specifically allow spectral spreading consistent with psychoacoustic knowledge. The windowing may be performed by multiplying the first autocorrelation sequence by a time domain window sequence.

According to an optional feature of the invention, the windowing corresponds to a psychoacoustic bandwidth corresponding to a Bark bandwidth.

This may allow improved performance, and/or higher quality.

According to an optional feature of the invention, the windowing corresponds to a psychoacoustic bandwidth corresponding to an Equivalent Rectangular Bandwidth (ERB).

This may allow improved performance and/or higher quality.

According to an optional feature of the invention, the modifying means is arranged to bound the second autocorrelation sequence by a minimum value autocorrelation sequence.

This may allow improved performance, higher quality, reduced complexity and/or facilitated implementation. In particular, the feature may allow a low complexity way of providing improved quality linear predictive coding at low signal volumes.

According to an optional feature of the invention, the modifying means is arranged to determine the second autocorrelation sequence as a summation of at least a first term corresponding to the minimum value autocorrelation sequence and a second term determined in response to the first autocorrelation sequence.

This may allow improved performance, higher quality, reduced complexity and/or facilitated implementation.

According to an optional feature of the invention, the modifying means is arranged to scale at least one of the first and the second term by a scale factor corresponding to a psychoacoustic significance of the first term relative to the second term.

This may allow improved performance, higher quality, reduced complexity and/or facilitated implementation. In particular, the scale factor may allow a low complexity way of weighting the different psychoacoustic effects.

According to an optional feature of the invention, the minimum value autocorrelation sequence corresponds to a threshold-in-quiet curve.

This may allow improved performance, higher quality, reduced complexity and/or facilitated implementation.

According to an optional feature of the invention, the linear predictive coding is a Laguerre linear predictive coding and the determining means is arranged to determine a covariance sequence between the audio signal and a Laguerre filtered version of the audio signal in response to the second autocorrelation sequence.

This may allow improved performance, higher quality, reduced complexity and/or facilitated implementation of a Laguerre linear predictive coding.

According to an optional feature of the invention, the first autocorrelation sequence is a warped autocorrelation sequence.

This may allow improved performance, higher quality, reduced complexity and/or facilitated implementation. The linear predictive coding may be a warped linear predictive coding.

According to an optional feature of the invention, the first autocorrelation sequence is a filtered warped autocorrelation sequence.

This may allow improved performance, higher quality, reduced complexity and/or facilitated implementation. The linear predictive coding may be a Laguerre linear predictive coding.

According to an optional feature of the invention, the determining means is arranged to determine the linear predictive coefficients by a minimization of a signal power measure for an error signal associated with an input signal to a linear prediction filter employing the linear predictive coding coefficients, the input signal being characterized by the second autocorrelation sequence.

This may allow improved performance, higher quality, reduced complexity and/or facilitated implementation. The input signal may be an input signal having an autocorrelation sequence corresponding to the second autocorrelation sequence and the error signal may be determined as the output of the linear prediction analysis filter.

According to an optional feature of the invention, the determining means is arranged to determine the linear predictive coefficients solving the linear equations given by:

Q·α=P

where Q is a matrix comprising coefficients determined in response to the second autocorrelation sequence, P is a vector comprising coefficients determined in response to the second autocorrelation sequence and α is a vector comprising the linear predictive coefficients.

This may allow improved performance, higher quality, reduced complexity and/or facilitated implementation.

According to an optional feature of the invention, the modifying means is arranged to determine the second autocorrelation sequence substantially according to:

r(k)=t(k)+βr(k)w(k)

where r(k) is the second autocorrelation sequence, β is a scale factor, w(k) is a windowing sequence and t(k) is a threshold-in-quite autocorrelation sequence.

This may allow improved performance, higher quality, reduced complexity and/or facilitated implementation.

According to another aspect of the invention, there is provided a linear predictive coder for coding an audio signal, the coder comprising: means for generating signal segments for the audio signal; means for generating a first autocorrelation sequence for each signal segment; modifying means for generating a second autocorrelation sequence for each signal segment by modifying the first autocorrelation sequence in response to at least one psychoacoustic characteristic; and determining means for determining linear predictive coding coefficients for each signal segment in response to the second autocorrelation sequence.

According to another aspect of the invention, there is provided an audio recording device comprising a coder as described above.

According to another aspect of the invention, there is provided a transmitter for transmitting an audio signal, the transmitter comprising: means for receiving the audio signal; means for generating signal segments for the audio signal; means for generating a first autocorrelation sequence for each signal segment; modifying means for generating a second autocorrelation sequence for each signal segment by modifying the first autocorrelation sequence in response to at least one psychoacoustic characteristic; linear predictive coding means for determining linear predictive coding coefficients for each signal segment in response to the second autocorrelation sequence; means for generating encoded data for the audio signal, the encoded data comprising the linear predictive coding coefficients; and means for transmitting the encoded data.

According to another aspect of the invention, there is provided a transmission system for transmitting an audio signal, the transmission system comprising: a transmitter comprising: means for receiving the audio signal, means for generating signal segments for the audio signal, means for generating a first autocorrelation sequence for each signal segment, modifying means for generating a second autocorrelation sequence for each signal segment by modifying the first autocorrelation sequence in response to at least one psychoacoustic characteristic, linear predictive coding means for determining linear predictive coding coefficients for each signal segment in response to the second autocorrelation sequence, means for generating encoded data for the audio signal, the encoded data comprising the linear predictive coding coefficients, and means for transmitting the encoded data to a receiver; and the receiver comprising: means for receiving the encoded data, a linear predictive filter for generating a decoded signal, and means for setting coefficients of the linear predictive synthesis filter in response to the linear predictive coding coefficients of the encoded data.

According to another aspect of the invention, there is provided a method of linear predictive coding of an audio signal, the method comprising: generating signal segments for the audio signal; generating a first autocorrelation sequence for each signal segment; generating a second autocorrelation sequence for each signal segment by modifying the first autocorrelation sequence in response to at least one psychoacoustic characteristic; and determining linear predictive coding coefficients for each signal segment in response to the second autocorrelation sequence.

According to another aspect of the invention, there is provided a method of transmitting an audio signal, the method comprising: receiving the audio signal; generating signal segments for the audio signal; generating a first autocorrelation sequence for each signal segment; generating a second autocorrelation sequence for each signal segment by modifying the first autocorrelation sequence in response to at least one psychoacoustic characteristic; determining linear predictive coding coefficients for each signal segment in response to the second autocorrelation sequence; generating encoded data for the audio signal, the encoded data comprising the linear predictive coding coefficients; and transmitting the encoded data.

According to another aspect of the invention, there is provided a method of transmitting and receiving an audio signal, the method comprising: a transmitter performing the steps of: receiving the audio signal, generating signal segments for the audio signal, generating a first autocorrelation sequence for each signal segment, generating a second autocorrelation sequence for each signal segment by modifying the first autocorrelation sequence in response to at least one psychoacoustic characteristic, determining linear predictive coding coefficients for each signal segment in response to the second autocorrelation sequence, generating encoded data for the audio signal, the encoded data comprising the linear predictive coding coefficients, and transmitting the encoded data to a receiver; and the receiver performing the steps of: receiving the encoded data, a decoded signal using a linear predictive filter for generating, and setting coefficients of the linear predictive synthesis filter in response to the linear predictive coding coefficients of the encoded data.

These and other aspects, features and advantages of the invention will be apparent from and elucidated with reference to the embodiment(s) described hereinafter.

Embodiments of the invention will be described, by way of example only, with reference to the drawings, in which

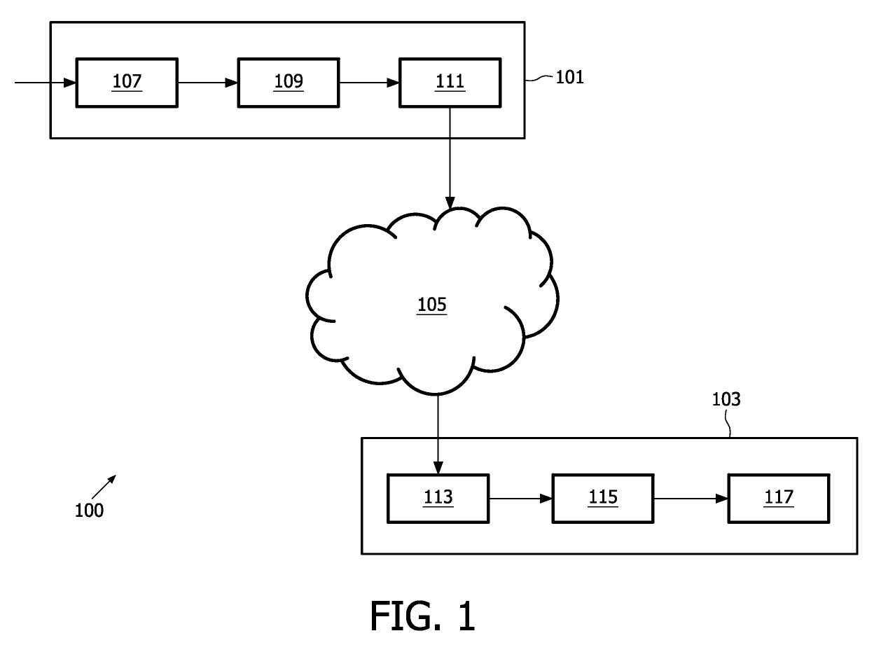

FIG. 1 illustrates a transmission system for communication of an audio signal in accordance with some embodiments of the invention;

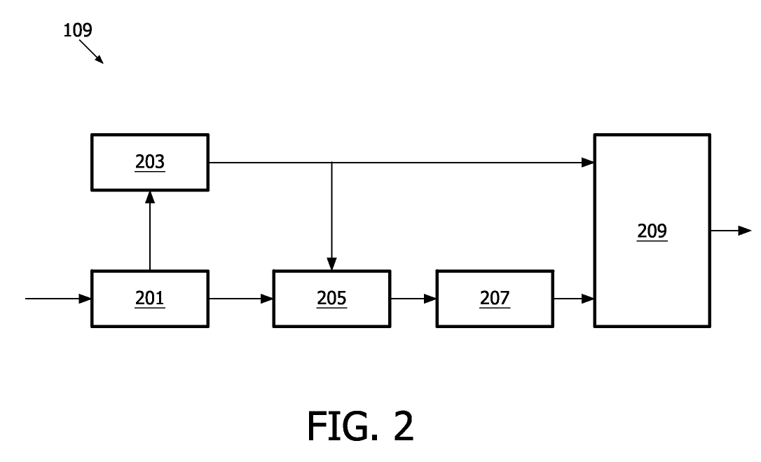

FIG. 2 illustrates a linear predictive coder in accordance with some embodiments of the invention;

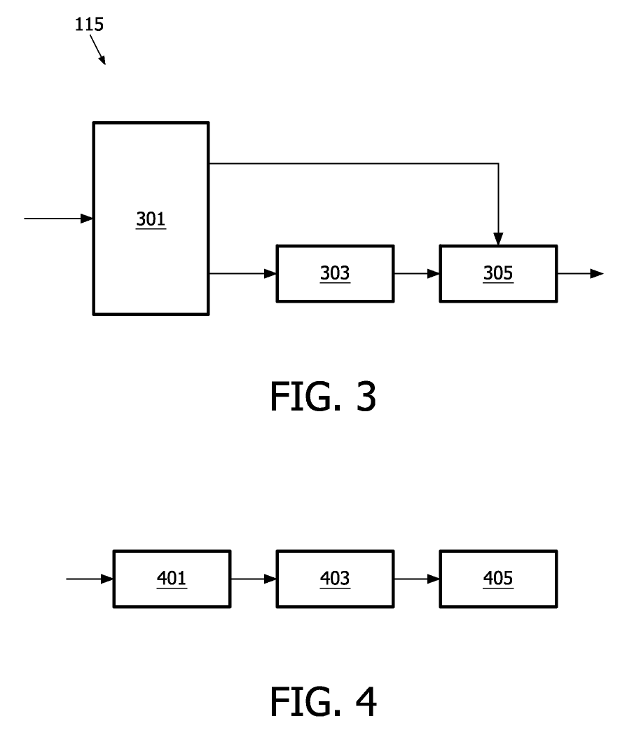

FIG. 3 illustrates a linear predictive decoder;

FIG. 4 illustrates elements of a linear predictive coder in accordance with some embodiments of the invention; and

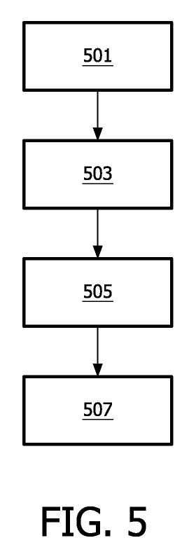

FIG. 5 illustrates a method of linear predictive coding of an audio signal in accordance with some embodiments of the invention.

FIG. 1 illustrates a transmission system 100 for communication of an audio signal in accordance with some embodiments of the invention. The transmission system 100 comprises a transmitter 101 which is coupled to a receiver 103 through a network 105 which specifically may be the Internet.

In the specific example, the transmitter 101 is a signal recording device and the receiver is a signal player device 103 but it will be appreciated that in other embodiments a transmitter and receiver may used in other applications and for other purposes. For example, the transmitter 101 and/or the receiver 103 may be part of a transcoding functionality and may e.g. provide interfacing to other signal sources or destinations.

In the specific example where a signal recording function is supported, the transmitter 101 comprises a digitizer 107 which receives an analog signal that is converted to a digital PCM signal by sampling and analog-to-digital conversion.

The digitizer 107 is coupled to a Linear Predictive (LP) coder 109 of FIG. 1 which encodes the PCM signal in accordance with a linear predictive coding algorithm. The LP coder 109 is coupled to a network transmitter 111 which receives the encoded signal and interfaces to the Internet 105. The network transmitter may transmit the encoded signal to the receiver 103 through the Internet 105.

FIG. 2 illustrates the LP coder 109 in more detail.

The coder 109 receives a digitized (sampled) audio signal. For clarity and brevity, it is assumed that the input signal comprises only real values but it will be appreciated that in some embodiments the values may be complex.

The coder comprises a segmentation processor 201 which segments the received signal into individual segment frames. Specifically, the input signal is segmented into a number of sample blocks of a given size e.g. corresponding to 20 msec intervals. The encoder then proceeds to generate prediction data and residual signals for each individual frame.

Specifically, the segments are fed to a prediction controller 203 which determines parameters for the prediction filters to be applied during the encoding and decoding process. The prediction controller 203 specifically determines filter coefficients for a linear predictive analyzer 205 which incorporates a Linear Predictive Analysis (LPA) filter.

The linear predictive analyzer 205 furthermore receives the input signal samples and determines an error signal between the predicted values and the actual input samples.

The error signals are fed to a coding unit 207 which encodes and quantizes the error signal and generates a corresponding bit stream.

The coding unit 207 and the prediction controller 203 are coupled to a multiplexer 209 which combines the data generated by the encoder into a combined encoded signal.

The receiver 103 comprises a network receiver 113 which interfaces to the Internet 105 and which is arranged to receive the encoded signal from the transmitter 101.

The network receiver 111 is coupled to a Linear Prediction (LP) decoder 115. The LP decoder 115 receives the encoded signal and decodes it in accordance with a linear predictive decoding algorithm.

FIG. 3 illustrates the LP decoder 115 in more detail. The LP decoder 115 comprises a de-multiplexer 301 which separates the linear predictive coefficients and the encoded error signal samples from the received bit stream. The error signal samples are fed to a decoding processor 303 which regenerates the error signal. The demultiplexer 301 and the decoding processor 303 are coupled to a linear predictive synthesizer (305) comprising a Linear Predictive Synthesis (LPS) filter. The coefficients of the LPS filter are set to the received coefficient values and the filter is fed with the regenerated error signal thereby (substantially) recreating the original audio signal.

In the specific example where a signal playing function is supported, the receiver 103 further comprises a signal player 117 which receives the decoded audio signal from the decoder 115 and presents this to the user. Specifically, the signal player 113 may comprise a digital-to-analog converter, amplifiers and speakers as required for outputting the decoded audio signal.

Different linear predictive coding algorithms may be employed in the system of FIG. 1. Specifically, a standard linear prediction, a warped linear prediction or a Laguerre linear predictive coding technique can be employed. The transfer function H(z) of the LPA filter is

$$H ( z ) = 1 - {\sum }_{k = 1}^{K} {α}_{k} {G}_{k} ( z )$$

where in these examples Gₖ(Z) is given by:

### Standard Linear Prediction:

$${G}_{k} ( z ) = {z}^{- k}$$

$$and thus$$

$$H ( z ) = 1 - {\sum }_{k = 1}^{K} {α}_{k} {z}^{- k}$$

### Warped Linear Prediction (WLP):

$${G}_{k} ( z ) = {( \frac{- λ + {z}^{- 1}}{1 - λ {z}^{- 1}} )}^{k}$$

$$and thus$$

$$H ( z ) = 1 - {\sum }_{k = 1}^{K} {{α}_{k} ( \frac{- λ + {z}^{- 1}}{1 - λ {z}^{- 1}} )}^{k}$$

Laguerre based Linear Prediction:

$${G}_{k} ( z ) = \frac{{z}^{- 1} \sqrt{1 - {λ}^{2}}}{1 - λ {z}^{- 1}} {( \frac{- λ + {z}^{- 1}}{1 - λ {z}^{- 1}} )}^{k - 1}$$

$$and thus$$

$$H ( z ) = 1 - \frac{{z}^{- 1} \sqrt{1 - {λ}^{2}}}{1 - λ {z}^{- 1}} {\sum }_{k = 1}^{K} {{α}_{k} ( \frac{- λ + {z}^{- 1}}{1 - λ {z}^{- 1}} )}^{k - 1}$$

The parameter λ is known as the warping or Laguerre parameter and allows a warping of the frequency scale in accordance with the psychoacoustic relevance of different frequencies. K is known as the order of the prediction filter. The LPS filter has a transfer function which is the inverse of the transfer function of the LPA filter, i.e. 1/H(z). Inside the filter, the partial transfers Gₖ(z) are coupled to signals yₖ with z transforms given by Yₖ(Z)=Gₖ(Z)X(Z) where X(z) is the z transform of the input signal x.

In the system, the LPA filter thus tries to estimate a current sample value from previous samples. Specifically, denoting the input samples x, the LPA filter for a simple standard linear prediction generates internally the sample:

$$\hat{x} ( n ) = {\sum }_{k = 1}^{K} {α}_{k} x ( n - k )$$

where αₖ are the prediction coefficients. The output of the LPA filter is the error sample e(n) generated by this estimate and is equal to

e(n)=x(n)−x(n)

where x(n) is the input signal sample value.

The prediction controller 203 determines the prediction coefficients αₖ such that the signal power measure for the error signal e(n) is minimized for the given signal segment.

Specifically, the prediction controller 203 is arranged to determine the prediction coefficients αₖ such that a minimum squared error for the samples in the segment is minimized. As will be appreciated by the person skilled in the art, the minimum may be found by determining the error signal measure function (specifically the minimum squared error) and setting the partial derivatives for the prediction coefficients αₖ to zero. As will be further appreciated by the person skilled in the art, this leads to K linear equations represented by:

Q·α=P

where Q is a K by K matrix comprising coefficients corresponding to autocorrelation values from an autocorrelation sequence of the signal, P is a K element vector comprising autocorrelation values from the autocorrelation sequence of the signal and α is a vector comprising the linear prediction coefficients.
Specifically, Q may be given by:

$$Q = [ \begin{matrix}r ( 0 ) & r ( 1 ) & r ( 2 ) & … & r ( K - 1 ) \\ r ( 1 ) & r ( 0 ) & r ( 1 ) & & r ( K - 2 ) \\ r ( 2 ) & r ( 1 ) & r ( 0 ) & & r ( K - 3 ) \\ ⋮ & & & ⋱ & \\ r ( K - 1 ) & r ( K - 2 ) & r ( K - 3 ) & & r ( 0 )\end{matrix} ]$$

and P may be given by:

$$P = [ \begin{matrix}r ( 1 ) \\ r ( 2 ) \\ r ( 3 ) \\ ⋮ \\ r ( K )\end{matrix} ]$$

where r(k) is a suitable autocorrelation sequence.

In conventional standard linear prediction, r(k) represents the autocorrelation sequence of the input signal, which can be directly measured from the input signal. In conventional warped linear prediction, the sequence r(k) represents the so-called warped autocorrelation sequence which can also be determined from the input signal.

In order to include psychoacoustic considerations, it has been proposed to determine a perceptually motivated spectrum like a masked threshold for the input signal and to use the autocorrelation associated with this spectrum in Q and P to determine the linear prediction coefficients. However, this is extremely complex as it requires that a psychoacoustic model is evaluated for each segment and the spectrum generated by the psycho-acoustic model is transformed to the associated autocorrelation sequence.

In the system of FIG. 1, the prediction controller 203 determines a psychoacoustically weighted autocorrelation sequence and uses this to determine the linear predictive coefficients. The psychoacoustically weighted autocorrelation sequence is determined from the autocorrelation sequence of the signal by direct and very simple operations. Thus, the LP coder of FIG. 2 allows psychoacoustic considerations to be used to improve the linear predictive coding while maintaining low complexity and computational resource demand and specifically without evaluating a psychoacoustic model for each segment.

FIG. 4 illustrates the prediction controller 203 in more detail.

The prediction controller 203 comprises an autocorrelation processor 401 which determines an autocorrelation sequence r′(k) from the received input signal. A new autocorrelation sequence is determined for each segment of the signal.

The autocorrelation processor 401 is coupled to a modification processor 403 which determines the psychoacoustically weighted autocorrelation sequence \tilde{r}(k) from the autocorrelation sequence r′(k) of the signal.

The psychoacoustically weighted autocorrelation sequence is then sent to a prediction coefficient processor 405 which determines the prediction coefficients for the LPA (and LPS) filter. In the example of a standard linear prediction, the prediction coefficient processor 405 solves the linear equations

Q·α=P

using the psychoacoustically weighted autocorrelation sequence of the input signal. Thus in the example r(k)=\tilde{r}(k). It will be appreciated that any suitable algorithm for solving these equations may be used, such as e.g. the Levinson recursion algorithm well known to the person skilled in the art.

It will be appreciated that any suitable operation or function for psychoacoustically weighting the autocorrelation sequence may be used.

Specifically, a windowing operation may be applied to the autocorrelation sequence in each signal segment. For example, the autocorrelation sequence of the input signal may be modified by a time domain multiplication with a predetermined window w(k). This multiplication in the time domain will correspond to a convolution in the frequency domain thereby providing a spectral spreading which may reflect the human perception of sound.

In particular, it may be advantageous to multiply the autocorrelation sequence by a window function that has a spectral bandwidth reflecting a psychoacoustically relevant distance and specifically the window can be selected to have a bandwidth of a Bark or Equivalent Rectangular Bandwidth (ERB) band at some specific frequency. Specifically this may allow a spectral shaping reflecting psychoacoustic characteristics.

Additionally or alternatively, the modification processor 403 may impose a lower bound on the values of the psychoacoustically weighted autocorrelation sequence. For example, an autocorrelation sequence that corresponds to the human perception at lower signal amplitudes can be determined. Such a characteristic is generally known as a threshold-in-quiet curve. The threshold-in-quiet curve thus corresponds to the minimum signal levels that are considered perceivable by a user. An autocorrelation sequence corresponding to this threshold-in-quiet curve can be determined and used as minimum values for the psychoacoustically weighted autocorrelation sequence.

For example, after performing a windowing operation on the autocorrelation sequence of the signal, each resultant sample can be compared to the sequence corresponding to the threshold-in-quiet and if any determined value is lower than the corresponding value of the threshold-in-quiet, the threshold-in-quiet value is used instead. As another example, the threshold-in-quiet autocorrelation sequence may be added as a term in the determination of the psychoacoustically weighted autocorrelation sequence.

Bounding the psychoacoustically weighted autocorrelation sequence by a minimum value autocorrelation sequence ensures that the resulting autocorrelation sequence corresponds more closely to that derived from a psycho-acoustic model and that especially for low-amplitude level input signals an increased coding gain is achieved.

As a specific example, the modification processor 403 can determine the psychoacoustically weighted autocorrelation sequence substantially as:

\tilde{r}(k)=t(k)+βr′(k)w(k)

where \tilde{r}(k) is the psychoacoustically weighted autocorrelation sequence, β is a scale factor, w(k) is a windowing sequence and t(k) is a minimum value autocorrelation sequence which specifically may be a threshold-in-quiet autocorrelation sequence.

In this example, the scale factor β is a design parameter that allows the relative impact of the threshold-in-quiet autocorrelation sequence and the windowing to be adjusted.

This approach may specifically be based on a realization that the masking curve at high energy intensity is, in a first-order approximation, level independent in shape. Thus, at high intensity levels linear prediction should be able to give a fair to good approximation of the shape of the masking curve when using appropriate linear predication systems (such as WLP or PLP) and using appropriate spectral smoothing. Furthermore, at low intensity levels, the threshold-in-quiet is an important part of the masking curve.

The psychoacoustic weighting of the autocorrelation sequence used for determining the linear prediction coefficients allows a much improved linear prediction to be performed that can more accurately reflect how the encoded signal is perceived by a user. Furthermore, the approach requires very few and simple operations and can easily be implemented without any significant complexity or computational resource increase.

At the cost of extra computational complexity, many refinements can be incorporated. For instance, the autocorrelation sequence may be filtered in order to emphasize particular frequency regions; the factor β can be made input level dependent etc.

The above example has focused on an example using a standard linear prediction. However, it will be appreciated that the described principles apply equally well to other and more complex linear predictions, such as warped linear prediction and Laguerre linear prediction.

Specifically, for warped linear prediction the autocorrelation sequences will be the warped autocorrelation sequences. Thus, initially the autocorrelation processor 401 can determine the warped autocorrelation sequence which can then be processed as described above to generate a warped psychoacoustically weighted autocorrelation sequence. The warped autocorrelation sequence is defined as

$$r ( 0 ) = {\sum }_{n} x ( n ) x ( n )$$

$$and$$

$$r ( k ) = {\sum }_{n} x ( n ) {y}_{k} ( n )$$

with k=1, . . . , K and with yₖ the response of the filter Gₖ(Z) in the warped linear predictor to the input signal x. The sequence is then used to determine the linear prediction coefficients. Specifically, it will be appreciated that the warping performed corresponds to filtering the incoming signal by a sequence of all-pass filters and the warped autocorrelation sequence is determined as the covariances of the outputs of these all-pass filters.

In the case of a Laguerre linear prediction, the sequence r(k) is given by

$$r ( k ) = {\sum }_{n} {y}_{1} ( n ) {y}_{k} ( n )$$

for k=1, . . . , K−1 with yₖ the response of the filter Gₖ(Z) in the Laguerre linear predictor to the input signal x. Comparing Gₖ of the warped linear predictor and that of the Laguerre linear predictor it may be appreciated that r(k) in the Laguerre case can be considered as a warped autocorrelation sequence of a filtered version of x where the filter G₀(z) is specified by

$${G}_{0} ( z ) = \frac{{z}^{- 1} \sqrt{1 - {λ}^{2}}}{1 - λ {z}^{- 1}}$$

For a Laguerre linear prediction, Q thus becomes a Toeplitz matrix comprising values of a psychoacoustically weighted autocorrelation of a Laguerre filtered signal. However, the relation between P and Q is slightly more complicated as P comprises values which are values of a covariance sequence for the input signal and a Laguerre filtered version of the audio signal. Thus,

$$P = [ \begin{matrix}p ( 1 ) \\ p ( 2 ) \\ p ( 3 ) \\ ⋮ \\ p ( K )\end{matrix} ]$$

$$where$$

$$p ( k ) = {\sum }_{n} x ( n ) {y}_{k} ( n )$$

for k=1, . . . , K with yₖ the response of the filter Gₖ(Z) in the Laguerre linear predictor to the input signal x.

For k>1, the relationship between the values of Q and P are given by:

r(k)=C₂p(k)+C₁p(k+1)

where

$${C}_{1} = \frac{λ}{\sqrt{1 - {λ}^{2}}}$$

$$and$$

$${C}_{2} = \frac{1}{\sqrt{1 - {λ}^{2}}}$$

where λ is the Laguerre parameter. Furthermore:

r(0)=p(0)+2C₁p(1)

where p(0) corresponds to the energy of the input signal:

$$p ( 0 ) = {\sum }_{n} x ( n ) x ( n ) .$$

Specifically, the prediction controller 203 can perform the following steps for a Laguerre linear prediction.

Initially, the sequence p(k), k=0 . . . K, is determined.

p(K+1) is set to zero.

A first autocorrelation r′(k) is determined from p(k) using the above equations.

A psychoacoustically weighted autocorrelation \tilde{r}(k) is determined from

r(k)=t(k)+βr′(k)w(k)

w(k) may for example be determined as:

$$w ( k ) = ( \begin{matrix}1 - δ k & δ k < 1 , δ > 0 \\ 0 & elsewhere\end{matrix}$$

where, given the sampling frequency and the Laguerre parameter λ, δ is determined such that the spectral representation of w(k) has a bandwidth of e.g. 1 Bark. Other window choices like Hanning, Hamming are also feasible.

A compensated covariance sequence \tilde{p}(k) is then calculated from \tilde{r}(k) using the above presented relationships between p(k) and r(k).

The prediction coefficients processor 405 then determines the prediction coefficients for the LPA filter from

Q·α=P

where the coefficients of Q and P are taken from \tilde{r}(k) and \tilde{p}(k).

FIG. 5 illustrates a method of linear predictive coding of an audio signal.

The method initiates in step 501 wherein signal segments are generated for the audio signal.

Step 501 is followed by step 503 wherein a first autocorrelation sequence for each signal segment is generated.

Step 503 is followed by step 505 wherein a second autocorrelation sequence is generated for each signal segment by modifying the first autocorrelation sequence in response to at least one psychoacoustic characteristic.

Step 505 is followed by step 507 wherein linear predictive coding coefficients are determined for each signal segment in response to the second autocorrelation sequence.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for linear predictive coding of an audio signal, the apparatus comprising:
means (201) for generating signal segments for the audio signal;
means (401) for generating a first autocorrelation sequence for each signal segment;
modifying means (403) for generating a second autocorrelation sequence for each signal segment by modifying the first autocorrelation sequence in response to at least one psychoacoustic characteristic; and
determining means (405) for determining linear predictive coding coefficients for each signal segment in response to the second autocorrelation sequence.

2. The apparatus of claim 1 wherein the modifying means (403) is arranged to perform a windowing of the first autocorrelation sequence.

3. The apparatus of claim 2 wherein the windowing corresponds to a psychoacoustic bandwidth corresponding to a Bark bandwidth.

4. The apparatus of claim 2 wherein the windowing corresponds to a psychoacoustic bandwidth corresponding to an Equivalent Rectangular Bandwidth (ERB).

5. The apparatus of claim 1 wherein the modifying means (403) is arranged to bound the second autocorrelation sequence by a minimum value autocorrelation sequence.

6. The apparatus of claim 5 wherein the modifying means (403) is arranged to determine the second autocorrelation sequence as a summation of at least a first term corresponding to the minimum value autocorrelation sequence and a second term determined in response to the first autocorrelation sequence.

7. The apparatus of claim 6 wherein the modifying means (403) is arranged to scale at least one of the first and the second term by a scale factor corresponding to a psychoacoustic significance of the first term relative to the second term.

8. The apparatus of claim 4 wherein the minimum value autocorrelation sequence corresponds to a threshold-in-quiet curve.

9. The apparatus of claim 1 wherein the linear predictive coding is a Laguerre linear predictive coding and the determining means is arranged to determine a covariance sequence between the audio signal and a Laguerre filtered version of the audio signal in response to the second autocorrelation sequence.

10. The apparatus of claim 1 wherein the first autocorrelation sequence is a warped autocorrelation sequence.

11. The apparatus of claim 1 wherein the first autocorrelation sequence is a filtered warped autocorrelation sequence.

12. The apparatus of claim 1 wherein the determining means (405) is arranged to determine the linear predictive coefficients by a minimization of a signal power measure for an error signal associated with an input signal to a linear prediction filter employing the linear predictive coding coefficients, the input signal being characterized by the second autocorrelation sequence.

13. The apparatus of claim 1 wherein the determining means (405) is arranged to determine the linear predictive coefficients solving the linear equations given by:
Q·α=P
where Q is a matrix comprising coefficients determined in response to the second autocorrelation sequence, P is a vector comprising coefficients determined in response to the second autocorrelation sequence and α is a vector comprising the linear predictive coefficients.

14. The apparatus of claim 1 wherein the modifying means (403) is arranged to determine the second autocorrelation sequence substantially according to:
\tilde{r}(k)=t(k)+βr(k)w(k)
where r(k) is the second autocorrelation sequence, β is a scale factor, w(k) is a windowing sequence and t(k) is a threshold-in-quite autocorrelation sequence.

15. A linear predictive coder for coding an audio signal, the coder comprising:
means (201) for generating signal segments for the audio signal;
means (401) for generating a first autocorrelation sequence for each signal segment;
modifying means (403) for generating a second autocorrelation sequence for each signal segment by modifying the first autocorrelation sequence in response to at least one psychoacoustic characteristic; and
determining means (405) for determining linear predictive coding coefficients for each signal segment in response to the second autocorrelation sequence.

16. An audio recording device comprising a coder according to claim 15.

17. A transmitter (101) for transmitting an audio signal, the transmitter comprising:
means (107) for receiving the audio signal;
means (201) for generating signal segments for the audio signal;
means (401) for generating a first autocorrelation sequence for each signal segment;
modifying means (403) for generating a second autocorrelation sequence for each signal segment by modifying the first autocorrelation sequence in response to at least one psychoacoustic characteristic;
linear predictive coding means (405) for determining linear predictive coding coefficients for each signal segment in response to the second autocorrelation sequence;
means (209) for generating encoded data for the audio signal, the encoded data comprising the linear predictive coding coefficients; and
means (111) for transmitting the encoded data.

18. A transmission system for transmitting an audio signal, the transmission system comprising:
a transmitter (101) comprising:
means (107) for receiving the audio signal,
means (201) for generating signal segments for the audio signal,
means (401) for generating a first autocorrelation sequence for each signal segment,
modifying means (403) for generating a second autocorrelation sequence for each signal segment by modifying the first autocorrelation sequence in response to at least one psychoacoustic characteristic,
linear predictive coding means (405) for determining linear predictive coding coefficients for each signal segment in response to the second autocorrelation sequence,
means for generating encoded data (209) for the audio signal, the encoded data comprising the linear predictive coding coefficients, and
means for transmitting (111) the encoded data to a receiver; and
the receiver (103) comprising:
means (113) for receiving the encoded data,
a linear predictive filter (305) for generating a decoded signal, and
means (301) for setting coefficients of the linear predictive synthesis filter (305) in response to the linear predictive coding coefficients of the encoded data.

19. A method of linear predictive coding of an audio signal, the method comprising:
generating (501) signal segments for the audio signal;
generating (503) a first autocorrelation sequence for each signal segment;
generating (505) a second autocorrelation sequence for each signal segment by modifying the first autocorrelation sequence in response to at least one psychoacoustic characteristic; and
determining (507) linear predictive coding coefficients for each signal segment in response to the second autocorrelation sequence.

20. A method of transmitting an audio signal, the method comprising:
receiving the audio signal;
generating (501) signal segments for the audio signal;
generating (503) a first autocorrelation sequence for each signal segment;
generating (505) a second autocorrelation sequence for each signal segment by modifying the first autocorrelation sequence in response to at least one psychoacoustic characteristic;
determining (507) linear predictive coding coefficients for each signal segment in response to the second autocorrelation sequence;
generating encoded data for the audio signal, the encoded data comprising the linear predictive coding coefficients; and
transmitting the encoded data.

21. A method of transmitting and receiving an audio signal, the method comprising:
a transmitter (901) performing the steps of:
receiving the audio signal,
generating (501) signal segments for the audio signal,
generating (503) a first autocorrelation sequence for each signal segment,
generating (505) a second autocorrelation sequence for each signal segment by modifying the first autocorrelation sequence in response to at least one psychoacoustic characteristic,
determining (507) linear predictive coding coefficients for each signal segment in response to the second autocorrelation sequence,
generating encoded data for the audio signal, the encoded data comprising the linear predictive coding coefficients, and
transmitting the encoded data to a receiver; and
the receiver performing the steps of:
receiving the encoded data,
a decoded signal using a linear predictive filter for generating, and
setting coefficients of the linear predictive synthesis filter in response to the linear predictive coding coefficients of the encoded data.

22. A computer program product for executing the method of claim 19.
